(19) United States
(12) Patent Application Publication
(10) Pub. No.: US 2010/0005403 A1
(43) Pub. Date: Jan. 7, 2010

(54) Monitoring viewable times of webpage elements on single webpages

(76) Inventors: Gadiel Z. Rozmaryn, Silver Spring, MD (US); Stephen Shaffer, Falls Church, VA (US)

Correspondence Address: MAIER & MAIER, PLLC, 1000 DUKE STREET, ALEXANDRIA, VA, 22314, US

(21) Appl. No.: 12/216,291

(22) Filed: Jul. 2, 2008

(51) Int. Cl. G06F 15/16; G06F 3/048

(52) U.S. Cl. 715/760

(57) ABSTRACT

In accordance with at least one exemplary embodiment, methods, computer program products and systems for monitoring viewable times of webpage elements on single webpages are disclosed. An exemplary method for rotating webpage elements on a single webpage based on viewable time can include loading a single webpage having at least one first webpage element and other webpage content. A first viewable time can be determined for the first webpage element. The first viewable time can be compared to a first viewable time limit until the first viewable time reaches the first viewable time limit. At least one second webpage element can be loaded in place of the first webpage element on the single webpage. In at least one exemplary embodiment, the first and second webpage elements are web advertisements.

### BACKGROUND

Online advertising is a form of advertising that depends on the Internet and World Wide Web in delivering marketing messages to consumers. Online advertising is an important source of revenue for many businesses involved in e-commerce. Online advertisements are extensively used by numerous product (e.g., goods and/or services) providers to market their products. Online advertisements take a variety of forms and many forms are webpage-based. As a couple examples, banner advertisements (also commonly refer to as “web banners” and “banner ads”) and contextual advertisements, such as contextual advertisements appearing on search engine results pages or contextual advertisements that are design to match the content of non-search webpages that they appear on, are popular forms of online advertisements. Hypertext Markup Language (“HTML”) and Hypertext Transfer Protocol (“HTTP”) enable a webpage to be designed with one or more designated locations for inclusion of one or more advertisements.

Ad serving is heavily relied on in providing particular advertisements to a webpage. Particularly, ad serving is used to place advertisements at the designated locations on webpages. An ad server is a web server for the purpose of providing advertisements to webpages, among other tasks. Typically, ad serves include more than one of the following functionalities: uploading advertisements (including rich media advertisements and widgets) for webpages; trafficking advertisements according to business rules; targeting advertisements by content or by user; optimizing ad serving based on results, reporting impressions; reporting clicks-throughs; tracking post-impression and post-click activities; measuring and reporting interaction metrics; capping the frequency of advertisements provided to particular users; sequencing advertisements; behavioral-targeting of advertisements; and excluding competitors' advertisements on the same webpages at the same time.

Advertisements are displayed on webpages upon loading or refreshing. Advertisements remain in a static state on webpages until reloaded. In other words, the same advertisement (including rich media advertisements and widgets) will remain on a webpage after it is loaded until it is later reloaded or immediately refreshed. Having a webpage display the same advertisements until it is reloaded has traditionally posed little problem because most webpages were designed to be viewed for a relatively short period of time. Nevertheless, the current and ongoing evolution of the World Wide Web, sometimes referred to as Web 2.0, is placing greater emphasis on providing greater functionality to single webpages. Thus, the increased functionality tends to increase the time spent by users on certain webpages. For example, a single webpage including a rich internet application (“RIA”) is designed to interface with a user much like traditional desktop application and, thus, the single webpage will often remain loaded for a greater period of time. Other examples of single webpages likely to be loaded for greater periods of time include webpages for streaming media (e.g., movies, television shows, news, music, radio stations, etc.) whether the streaming media is provided live or on-demand.

RIAs are web applications designed with features and functionalities commonly found on desktop applications. Widely and currently used RIAs include popular web-based email applications and web-based word processing applications. RIAs typically run in a browser and do not require installation. They also often run locally in a secured environment commonly known as a sandbox. RIAs typically transfer the processing necessary for the user interface to the client computing device while maintaining the bulk of the data on the application server. They introduce an intermediate layer of code, often referred to as a client engine, between the client computing device and application server. This client engine is usually downloaded as part of the instantiation of the application and may be supplemented by further code downloads as use of the RIA progresses. The client engine acts as an extension of the browser and typically takes responsibility for rendering the user interface and communicating with the server. Typically, the client engine will asynchronously interact with the server.

### SUMMARY

According to at least one exemplary embodiment, a method of rotating webpage elements on a single webpage based on viewable time is disclosed. The method can include loading a single webpage having at least one first webpage element and other webpage content. A first viewable time can be determined for the first webpage element. The first viewable time can be compared to a first viewable time limit until the first viewable time reaches the first viewable time limit. At least one second webpage element can be loaded in place of the first webpage element on the single webpage.

In another exemplary embodiment, a computer program product embodied on a computer-readable medium for monitoring viewable times of webpage elements is disclosed. The computer program product can include at least one code segment configured to instruct a computer to determine whether a first webpage element or at least a portion thereof on a single webpage loaded by a browser is visible or partially visible on a display operatively connected to the computer. The computer program product can include at least one code segment configured to instruct the computer to track one or more first durations for when the first webpage element or at least a portion thereof is visible or partially visible on the display.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 diagrammatically illustrates an exemplary network;

FIG. 2 diagrammatically illustrates an exemplary computer system;

FIG. 3 is a block diagram of an exemplary single webpage including a first webpage element;

FIG. 4 is another block diagram of the exemplary single webpage including a second webpage element;

FIG. 5 is yet another block diagram of the exemplary single webpage including a nth webpage element; and

FIG. 6 is a flowchart illustrating an exemplary process for rotating webpage elements on a single webpage based on viewable time.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the invention,” “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

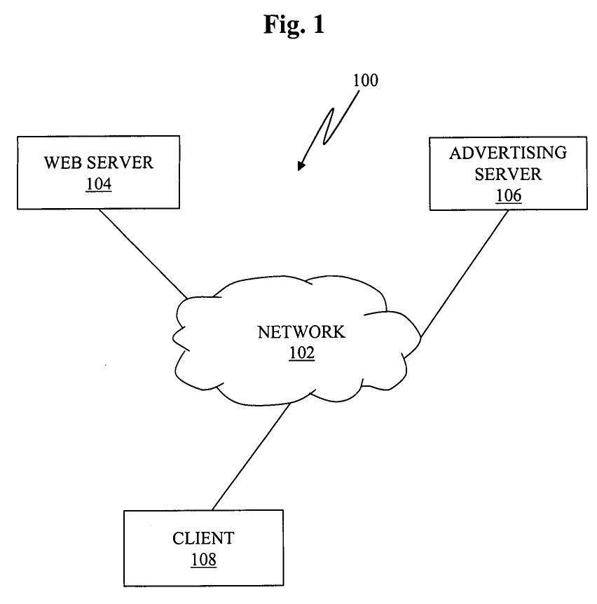

Referring to FIG. 1, exemplary network environment 100 is illustrated in simplified form. Environment 100 can include network 102. Network can connect at least one server, such as at least one web server 104 and at least one advertising server 106, with client computing devices 108 in networked communication. As shown, web server 104 and advertising server 106 can also be in communication. Network 102 or any portion thereof can be the Internet. Network 102 or any portion thereof can also be one or more of a local area network (“LAN”), a wide area network (“WAN”), a direct connection via ports (e.g., USB ports) and the like. Network 102 can include wired and wireless networks.

Web server 104 and advertising server 106 can each be a single server or more than one server. For example, web server 104 and advertising server 106 can each be a server farm at large enterprise scale. Moreover, web server 104 and advertising server 106 can have features and functionalities combined or can have features and functionalities distributed between multiple servers. Other servers can be connected to network 102, including at least one application server. Servers 102, 104 and any other servers can be connected to one or more conventional databases, such as relational databases and the like known to one having ordinary skill in the art.

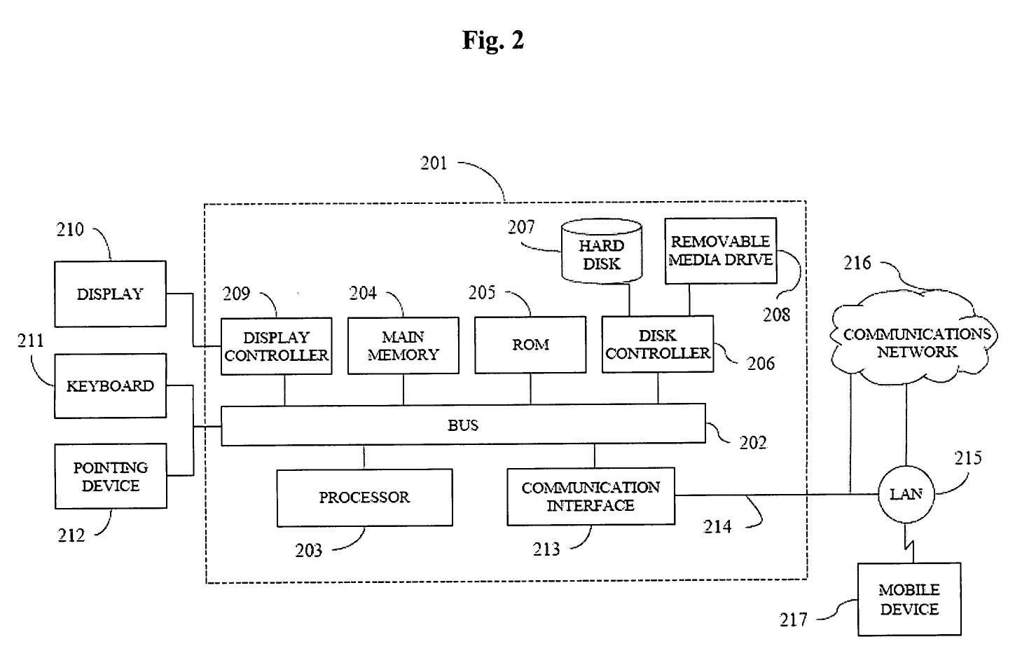

Webpages can be requested from and provided to client computing devices 108 by web server 104. Users of client computing devices 108 can be any person or any organization (having persons acting on behalf thereof). Without any intent to limit, users of client computing devices 108 can be defined as consumers who view online advertisements on webpages rendered by browser applications running on client computing devices 108 having displays in at least one exemplary embodiment. Client computing devices 108 can be any conventional personal computer or workstation (including desktop, laptop, tablet and like computers) and can be any other network-enabled device having browser functionality or the like (including mobile phones, personal digital assistants, media players, navigational systems and like devices). FIG. 2 illustrates an exemplary client computing device 108 for use with embodiments described herein. As discussed further below, client computing devices 108 can include software, such as browser applications for requesting, loading and rendering webpages. Still referring to FIG. 1, advertising server 106 can provide for the selection, transmittal and/or optimization of advertisements loaded in webpages by a browser application as is well known in the art.

FIG. 2 illustrates computer system 201 upon which at least one embodiment described herein may be implemented on. Computer system 201 can serve as client computing device 108 in exemplary embodiments and may also serve as a server in some embodiments. Computer system 201 includes bus 202 or other communication mechanism for communicating information, and processor 203 coupled with bus 202 for processing the information. Computer system 201 also includes main memory 204, such as a random access memory (“RAM”) or other dynamic storage device (e.g., dynamic RAM (“DRAM”), static RAM (“SRAM”), and synchronous DRAM (“SDRAM”)), coupled to bus 202 for storing information and instructions to be executed by processor 203. In addition, main memory 204 may be used for storing temporary variables or other intermediate information during the execution of instructions by processor 203. Computer system 201 further includes read only memory (“ROM”) 205 or other static storage device (e.g., programmable ROM (“PROM”), erasable PROM (“EPROM”), and electrically erasable PROM (“EEPROM”)) coupled to bus 202 for storing static information and instructions for processor 203.

Computer system 201 also includes disk controller 206 coupled to bus 202 to control one or more storage devices for storing information and instructions, such as magnetic hard disk 207, and removable media drive 208 (e.g., floppy disk drive, read-only compact disc drive, read/write compact disc drive, compact disc jukebox, tape drive, and removable magneto-optical drive). The storage devices may be added to computer system 201 using an appropriate device interface (e.g., small computer system interface (“SCSI”), integrated device electronics (“IDE”), enhanced-IDE (“E-IDE”), direct memory access (“DMA”), or ultra-DMA).

Computer system 201 may also include a display controller 209 coupled to bus 202 to control display 210, such as a liquid crystal display (“LCD”), an organic light emitting diode (“OLED”), a flat panel display, a solid state display, a cathode ray tube (“CRT”), a projector and like display devices. Computer system 201 includes input devices, such as keyboard 211 and pointing device 212, for interacting with a computer user and providing information to the processor 203. Pointing device 212, for example, may be a mouse, a trackball, or a pointing stick for communicating direction information and command selections to processor 203 and for controlling cursor movement on display 210. In addition, a printer may provide printed listings of data stored and/or generated by computer system 201.

Computer system 201 performs a portion or all of the processing steps of the invention in response to processor 203 executing one or more sequences of one or more instructions contained in a memory, such as main memory 204. Such instructions may be read into the main memory 204 from another computer readable medium, such as hard disk 207 or a removable media drive 208. One or more processors in a multi-processing arrangement may also be employed to execute the sequences of instructions contained in main memory 204. In alternative embodiments, hard-wired circuitry may be used in place of or in combination with software instructions. Thus, embodiments are not limited to any specific combination of hardware circuitry and software.

As stated above, computer system 201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, Flash memory), DRAM, SRAM, SDRAM, or any other magnetic medium, compact discs (e.g., CD-ROM), or any other optical medium, a carrier wave (described below), or any other medium from which a computer can read.

Stored on any one or on a combination of computer readable media, computer system 201 includes software for controlling the same, for driving a device or devices for implementing embodiments, and for enabling computer system 201 to interact with a human user. Such software may include, but is not limited to, device drivers, operating systems, development tools, and applications software (e.g. a browser application). Such computer readable media further includes the computer program product described herein for performing all or a portion (if processing is distributed) of the processing performed in implementing embodiments.

The computer code devices (or segments) of the embodiments described herein may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to processor 203 for execution. A computer readable medium may take many forms, including but not limited to, non-volatile media, volatile media, and transmission media. Non-volatile media includes, for example, optical, magnetic disks, and magneto-optical disks, such as hard disk 207 or removable media drive 208. Volatile media includes dynamic memory, such as main memory 204. Transmission media includes coaxial cables, copper wire and fiber optics, including the wires that make up bus 202. Transmission media also may also take the form of acoustic or light waves, such as those generated during radio wave and infrared data communications.

Computer system 201 also includes communication interface 213 coupled to bus 202. Communication interface 213 provides a two-way data communication coupling to network link 214 that is connected to, for example, local area network (“LAN”) 215, or to another communications network 216 such as the Internet. For example, communication interface 213 may be a network interface card to attach to any packet switched LAN. As another example, communication interface 213 may be an asymmetrical digital subscriber line (“ADSL”) card, integrated services digital network (“ISDN”) card or a modem to provide a data communication connection to a corresponding type of communications line. Wireless links may also be implemented. In any such implementation, the communication interface 213 sends and receives electrical, electromagnetic or optical signals that carry digital data streams representing various types of information.

Network link 214 typically provides data communication through one or more networks to other data devices. For example, network link 214 may provide a connection to another computer through local network 215 (e.g., a LAN) or through equipment operated by a service provider, which provides communication services through communications network 216. Local network 214 and communications network 216 use, for example, electrical, electromagnetic, or optical signals that carry digital data streams, and the associated physical layer (e.g., CAT 5 cable, coaxial cable, optical fiber, etc). The signals through the various networks and the signals on network link 214 and through communication interface 213, which carry the digital data to and from computer system 201 maybe implemented in baseband signals, or carrier wave based signals. Computer system 201 can transmit and receive data, including program code, through network(s) 215 and 216, network link 214 and communication interface 213. Moreover, network link 214 may provide a connection through LAN 215 to mobile device 217 such as a personal digital assistant (PDA), laptop computer or mobile phone.

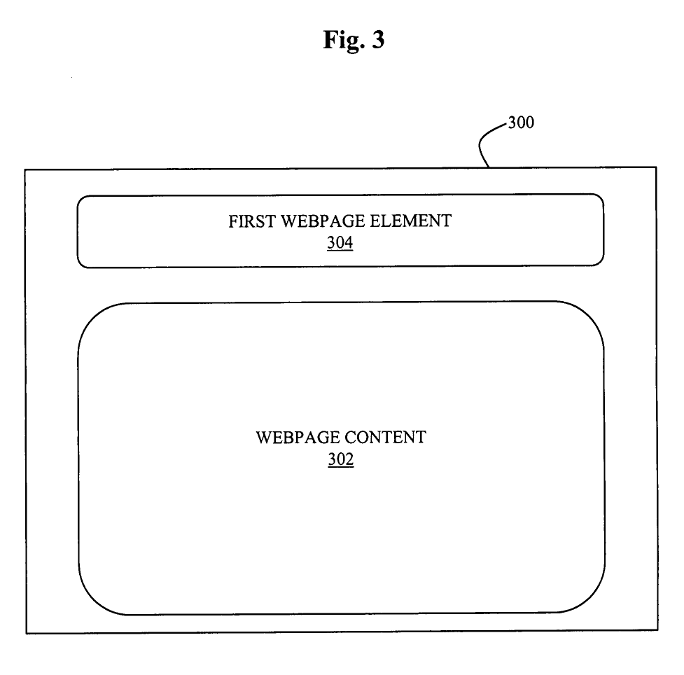

Referring to FIG. 3, a block diagram of an exemplary single webpage 300 is shown. Single webpage 300 can represent a webpage first loaded or reloaded on a display by a browser running on client computing device 108. Webpage 300 can be requested from and transmitted to client computing device 108 by web server 104. Webpage 300 can include webpage content 302, which can be any content capable of being conveyed by a webpage. Webpage content 302 can be in the form of text, images, video, audio and the like as well as any combination thereof. As a couple non-limiting examples, webpage content can include streaming media and RIA content. In the case of RIA content, the RIA can be provided by at least one application server.

At any position around or within webpage content 302 on webpage 300, one or more rotatable first webpage elements 304 can be loaded as designated by webpage 300. As shown, webpage 300 can include at least one first element 304. In a non-limiting manner, element 304 is shown at a top position on webpage 300. First element 304 can just as easily occupy a right side position, left side position, bottom position or any position there between on webpage 300. Additionally, more than one first element 304 can be loaded on webpage 300 and occupy any position thereon, as would readily be recognized by one having ordinary skill in the art.

In at least one exemplary embodiment, first element 304 can be a first web advertisement. Also, in at least one exemplary embodiment, first web advertisement 304 can be requested from and transmitted to client computing device 108 by advertising server 106. Single webpage 300 can include designated advertisement areas that can be populated by rotatable web advertisements selected and transmitted by advertising server 106. In other embodiments, first webpage element 304 can be any other distinct portion of a webpage known to one having ordinary skill in the art. For example, first element 304 can be an image, block of text, hypertext link, video, audio and any combination thereof.

The viewable time of first webpage element 304 can be monitored and determined. In at least one exemplary embodiment, viewable time may refer to when first element 304 is fully visible. In other exemplary embodiments, viewable time can refer to when a portion, whether any specific (and even pre-selected) portion or any portion in general, is viewable. Viewable time is an updatable, time-based measurement of the visual depiction of first element 304 or any portion thereof on the display of client computing device 108. In other words, viewable time refers to the time period that first element 304 or any portion thereof is visually depicted on a display in a manner that a user of client computing device 108 could physically view first element 304 if paying attention to the display. The viewable time can be updated by continuously, at least nearly so, or more intermittently tracking the time that first element 304 is viewable by a user of client computing device 108.

Determining the viewable time of first webpage element 304 or any portion thereof can involve one or more steps. After single webpage 300 has been transmitted over network 102 and loaded by the browser running on client computing device 108, determining the viewable time of first webpage element 304 or any portion thereof can involve determining whether webpage 300 or any portion thereof is visually rendered by the browser on the display of client computing device 108. For example, whether single webpage 300 or any portion thereof is presently viewable by a user of client computing device 108. If not, then first webpage element 304 is not viewable. If so, then determining the viewable time of first element 304 or any portion thereof can involve determining whether first webpage element 304 or any portion thereof is visible or partially visible on the display. If not, then first webpage element 304 is not viewable.

If so, then determining the viewable time of first webpage element 304 or any portion thereof can involve tracking one or more durations for when first webpage element 304 or any portion thereof is visible or partially visible on the display. The viewable time of first webpage element 304 or any portion thereof can then be determined by computation involving one or more recorded durations. Other steps may also be performed in determining viewable time or monitoring related thereto. For example, it can be determined whether first element 304 is not visible on the display. If not visible, then one or more durations can be tracked for when first element 304 is not visible. Likewise, it can be determined whether first element 304 is visually rendered in an active window, which often (although not necessarily) is the window closest to the foreground in the GUI of many operating systems for use with client computing device 108. If so, then one or more durations can be tracked for when first element 304 is in an active window.

In at least one exemplary embodiment, determining whether first webpage element 304 or any portion thereof is visible or partially visible on the display can involve detecting a plurality of properties. For example, detecting the resolution of the display (and GUI) can be performed. The extent of maximization of the window containing webpage 300 can be detected. The position of first webpage element 304 on webpage 300 can be detected. The position of any horizontal scrollbar of the window can be detected. The position of any vertical scrollbar of the window can be detected. Whether the window is in the closest foreground position or other Z-order position of the GUI can be detected. Whether any one or more portions of the window are obscured by any other open windows appearing closer to the foreground by Z-order position in the GUI. Indeed, other like detections will readily be recognized by one having ordinary skill in the art having the benefit of this disclosure. Also, one of ordinary skill in the art will readily recognized that not all of the above detections are necessary to determine whether first element 304 or any portion thereof is visible or partially visible. Once the display properties are detected, it can be determined whether first element 304 or any portion thereof is visible or partially visible by computation.

In at least one exemplary embodiment, the time component of viewable time can be tracked through timestamping. For example, a timestamp can be recorded when it is detected that first webpage element 304 or any portion thereof is viewable. Another timestamp can be recorded when first element 304 or any portion thereof is no longer detected as viewable or at any predetermined time interval. During monitoring, if first element 304 or any portion thereof becomes viewable after being not viewable, then another timestamp can be recorded. Yet another timestamp can be recorded when first element 304 or any portion thereof is no longer viewable or at any predetermined time interval. Thus, the time component of viewable time can be updatable by factoring in the timestamps and the durations (time periods) represented thereby as monitoring of viewable time occurs.

The viewable time for first webpage element 304 can be compared to a predetermined time limit until the viewable time reaches the predetermined time limit. The predetermine time limit can any number of seconds, minutes or hours. In embodiments where first webpage element 304 is a first web advertisement, a predetermined time limit can be selected to be set for seconds or minutes so that web advertisements can be rotated at a sufficient frequency so as to present numerous advertisements to users of client computing devices 108. For example, the predetermined time limit can be set at 5 seconds, 15 seconds, 30 seconds, 1 minute, 5 minutes, 15 minutes, etc. In advertising embodiments, it is contemplated that predetermined time limits of 5 seconds to 1 minute may prove to most beneficial to all parties involved in online advertising.

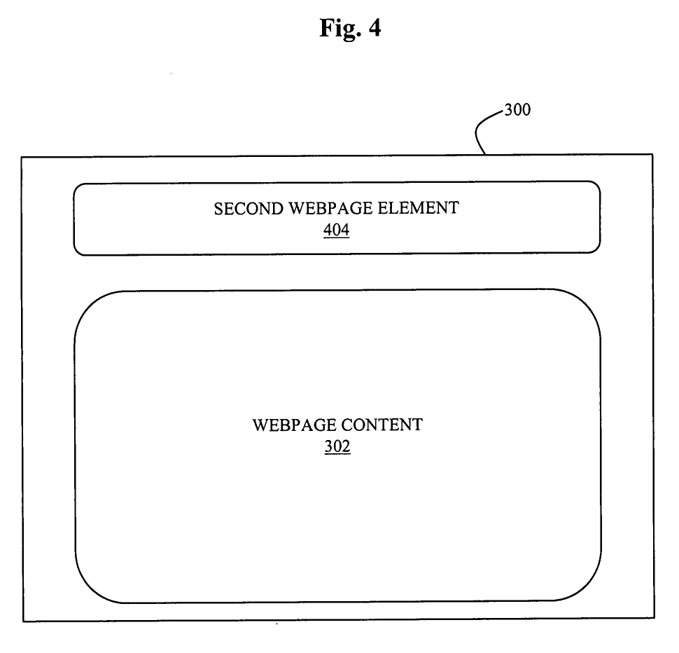

As shown in FIG. 4, upon or shortly after (e.g., depending on intermittence of monitoring) the viewable time of first webpage element 304 reaches the predetermined time limit, at least one second webpage element 404 can be loaded by the browser running on client computing device 108 and displayed by the display thereof. Second element 404 can be loaded in place of first element 304. First element 304 can be removed and no longer loaded on single webpage 300. Thus, second webpage element 404 can be rotated in for first webpage element 304; taking the place thereof. First element 304 and second element 404 do not necessarily have to be of the same graphical dimensions or same position in webpage 300, although this is contemplated to often be the case. In at least one exemplary embodiment, second webpage element 404 can be a second web advertisement. Second webpage element 404 can be similar to first webpage element 304 in all material aspects. A redundant description does not bear repeating here.

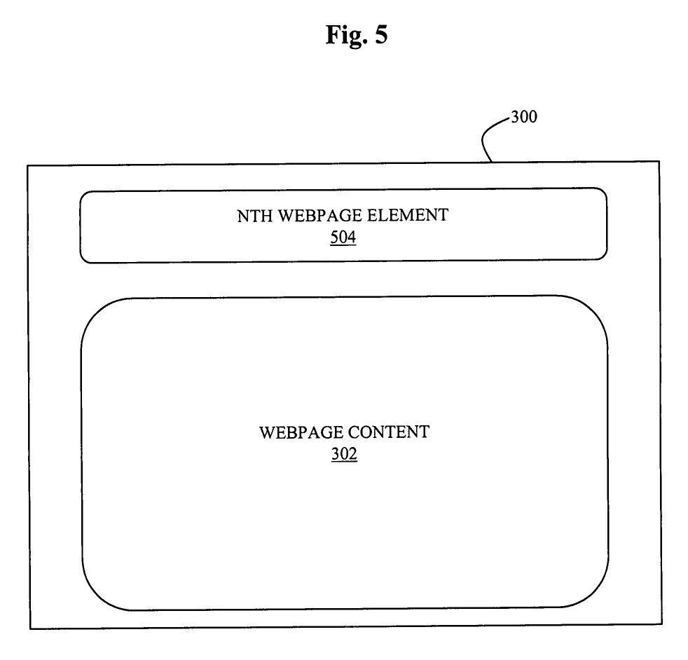

The viewable time for second webpage element 404 or any portion thereof can be determined as described above for element 304. The viewable time can be compared to a predetermined time limit, which may or may not be the same duration as the predetermine time limit for webpage element 304, until the viewable time reaches the predetermined time limit as described above for element 304. Upon or shortly after (e.g., depending on intermittence of monitoring) the viewable time of second webpage element 404 reaches the predetermined time limit, at least one third webpage element can be loaded by the browser running on client computing device 108 and displayed by the display thereof as described above for element 304. The third element can be loaded in place of second element 404 and can be similar in all material respects. As shown in FIG. 5, webpage elements can be rotated to nth webpage element 504 is reached or until single webpage 300 is no longer loaded by the browser running on client computing device 108. Webpage elements, such as web advertisements, can still be replaced during reloading on single webpage 300.

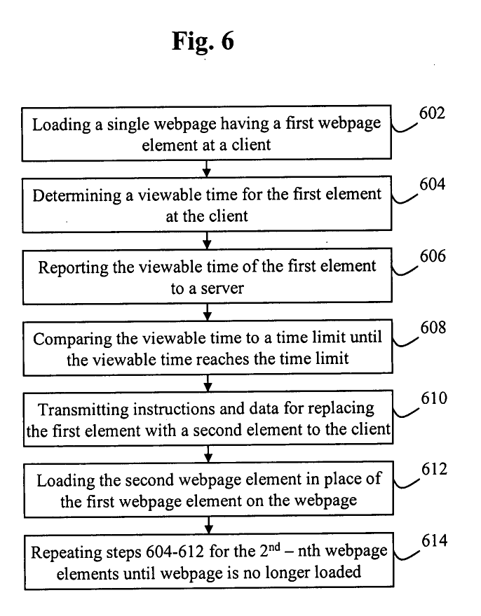

Referring to FIG. 6, a process for rotating webpage elements on a single webpage, such as webpage 300, based on viewable time is shown. The process can be employed to rotate webpage elements 304, 404, 504 as described above in conjunction with FIGS. 3-5. In at least one exemplary embodiment and as shown, client-server model and environment 100, as described above in conjunction with FIG. 1, is contemplated for employing the process. In other embodiments, the process may be employed locally in whole and not through distributed network 102. Also, in at least one exemplary embodiment, client-side instructions are processed by client computing device 108 in executing the process. The client-side computer program product can be an applet, script or other client-side computer interpretable or executable instructions that run within the context of a browser application. In alternative embodiments, the client-side computer program product can be a standalone application or processing can wholly occur at a server.

At step 602, single webpage 300 can be loaded with a browser running on client computing device 108 having an operatively connected display. Single webpage 300 may have been transmitted by web server 104 over network 102 at the request of the browser running on client computing device 108. Single webpage 300 can have at least one first webpage element 302 and other webpage content 304. In at least one exemplary embodiment, first webpage element 302 can be a web advertisement transmitted by advertising server 106 as provided for by single webpage 300. Also, webpage elements 404, 504 can be web advertisements provided by advertising server 106. At step 604, a viewable time for first webpage element 302 or any portion thereof can be determined at client computing device 108 by a computer program product embodied on a computer-readable medium for monitoring the viewable time of webpage elements.

The computer program product can have at least one code segment configured to instruct client computing device 108 to determine whether first webpage element 302 or any portion thereof on single webpage 300 is visible or partially visible on the display. It can also determine if first webpage element 302 is not visible. Another at least one code segment can track one or more first durations for when first webpage element 304 or any portion thereof is visible or partially visible, for example, by timestamping. It can also track the one or more durations for when first webpage element 304 is not visible. Yet another at least one code segment can compute a first viewable time by using the one or more durations. The first viewable time can be updated as further durations are tracked. Alternatively, computing can occur at a server, such as advertising server 106 in some embodiments, as the durations are reported to the server.

In determining viewable time for the first webpage element 304 at step 604, code segments can be configured to instruct client computing device 108 to make certain detections. A non-exhaustive list of detections can include: detecting the resolution of the display; detecting the extent of maximization of the window containing single webpage 300; detecting a position for first webpage element 304 on single webpage 300; detecting a position for any vertical scrollbar of the window; detecting a position for any horizontal scrollbar of the window; detecting whether the window is in the foreground position or other Z-order position of the GUI of client computing device 108; and detecting whether any portion of the window are obscured by any other windows appearing closer to the foreground by Z-order in the GUI. As will be readily recognized by one having ordinary skill the art, all of the described detections may not be necessary and other detections can be added to and substituted for the described detections.

At step 606, the viewable time for first webpage element 304 can be reported to a server, such as advertising server 106 in some embodiments, by transmitting such data over network 102. The data can be transmitted as instructed by a client-side computer program product having at least one code segment for causing client computing device 108 to do so. Alternatively, only the durations tracked can be reported and viewable time for first webpage element 304 can be computed at the server.

At step 608, the viewable time for first webpage element 304 can be compared to a time limit, which may be a predetermined time limit as described above, at the server. The viewable time can be compared to the time limit until it reaches the time limit. As one non-limiting example, the viewable time can be computed until it reaches a time limit set of 30 seconds.

Upon or shortly after it is determined that the viewable time for first webpage element 304 has reached the time limit, instructions for replacing the first webpage element 304 with second webpage element 404 can be transmitted, as data, to client computing device 108 at step 610. Also, data defining second webpage element 404 can be transmitted from the server, such as advertising server 106 in some embodiments, to client computing device 108.

At step 612, second webpage element 404 can be loaded by the browser running on client computing device 108 in place of first webpage element 304 on single webpage 300. As generally designated by step 614, second through nth webpage elements 404, 504 can be subjected to the process for rotating webpage elements on single webpage 300 based on viewable time as described above (i.e. steps 604 through steps 612 as step 602 is not repeated because webpage 300 remains loaded) until single webpage 300 is no longer loaded by the browser, which at that point may or may not be running on client computing device 108 (e.g., the browser may have been redirected to another webpage or closed).

In exemplary embodiments, multiple web advertisements can be shown in a time-dependent manner on a single webpage. This can increase the likelihood that consumers are exposed to advertisements they find relevant because more advertisements can be provided to them. It can also be used to charge advertisers based on advertisements that are actually viewable and it can be used to charge advertisers based on the viewable times of the advertisements, which is not readily available by conventional methods. Publishers can display more advertisements and can also collect revenue based on viewable times, which may increase revenue.

In other embodiments, analysis (e.g., marketing analysis) can be performed on data reported to at least one server. Also, webpage elements can be edited and updated without necessarily being wholly replaced. Moreover, input actions at client computing devices, including pointing device movements or selections (e.g, “clicks”), keyboard inputs and the like, can be monitored, detected and used in rotating webpage elements. Streaming and RIA media can be manipulated when it is determined that it is not viewable or when it has been determined that visibility has changed. For example, streaming media can be stopped, paused, started, fast forwarded, rewound and the like when it is determined that it is viewable or not viewable.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of rotating webpage elements on a single webpage based on viewable time, comprising:
loading a single webpage having at least one first webpage element and other webpage content;
determining a first viewable time for the first webpage element;
comparing the first viewable time to a first viewable time limit until the first viewable time reaches the first viewable time limit; and
loading at least one second webpage element in place of the first webpage element on the single webpage.

2. The method of claim 1, further comprising:
reporting the first viewable time of the first webpage element to at least one server on a network;
transmitting instructions to a client computing device over the network for effectuating the replacement of the first webpage element with the second webpage element; and
transferring data defining the second webpage element to the client computing device over the network;
wherein the step of comparing the first viewable time of the first webpage element to the first viewable time limit until the first viewable time reaches the first viewable time limit occurs at the at least one server.

3. The method of claim 1, further comprising:
determining a second viewable time for the second webpage element;
comparing the second viewable time to a second viewable time limit until the second viewable time reaches the second viewable time limit;
loading at least one third webpage element in place of the second webpage element on the single webpage; and
so on until the single webpage is no longer loaded.

4. The method of claim 1 wherein the step of determining the first viewable time of the first webpage element is performed by an applet, script or other client-side computer interpretable or executable instructions that run within the context of a browser application.

5. The method of claim 1 wherein the single webpage includes a rich internet application.

6. The method of claim 1 wherein the first webpage element is a first advertisement and the second webpage element is a second advertisement.

7. The method of claim 1 wherein the step of determining the first viewable time for the first webpage element, further comprises:
determining whether the single webpage or at least a portion thereof is visually rendered by a browser;
determining whether the first webpage element or at least a portion thereof is visible or partially visible on a display;
tracking one or more first durations for when the first webpage element or at least a portion thereof is visible or partially visible on the display; and
determining the first viewable time by computation involving the one or more first durations.

8. The method of claim 7 wherein the step of determining the first viewable time for the first webpage element, further comprises:
determining whether the first webpage element is not visible on the display; and
tracking one or more second durations for when the first webpage element is not visible on the display.

9. The method of claim 7 wherein the step of determining the first viewable time for the first webpage element, further comprises:
determining whether the single webpage is visually rendered in an active window on the display; and
tracking one or more third durations for when the single webpage is visually rendered in an active window.

10. The method of claim 7 wherein the step of determining whether the first webpage element or at least a portion thereof is visible or partially visible on the display, further comprises:
detecting a resolution of the display;
detecting the extent of maximization of a window containing the single webpage;
detecting a position for the first webpage element on the single webpage;
detecting a position for any vertical scrollbar of the window;
detecting a position for any horizontal scrollbar of the window; and
detecting whether the window is in a foreground position or other Z-order position in a GUI.

11. The method of claim 10 wherein the step of determining whether the first webpage element or at least a portion thereof is visible or partially visible on the display, further comprises:
detecting whether any one or more portions of the window are obscured by any other windows appearing closer to the foreground by Z-order position in the GUI; and
computing whether the first webpage element or at least a portion thereof is visible or partially visible on the display in accordance with such detections.

12. A computer program product embodied on a computer-readable medium for monitoring viewable times of webpage elements, the computer program product comprising at least one code segment configured to instruct a computer to:
determine whether a first webpage element or at least a portion thereof on a single webpage loaded by a browser is visible or partially visible on a display operatively connected to the computer; and
track one or more first durations for when the first webpage element or at least a portion thereof is visible or partially visible on the display.

13. The computer program product of claim 12 wherein the computer program product comprises at least one code segment configured to instruct a computer to:
compute a first viewable time by using the one or more first durations, the first viewable time being an updatable time-based measurement of the visual depiction of the first webpage element or at least a portion thereof on the display.

14. The computer program product of claim 12 wherein the computer program product comprises at least one code segment configured to instruct a computer to:
determine whether the first webpage element is not visible on the display; and
track one or more second durations for when the first webpage element is not visible on the display.

15. The computer program product of claim 14 wherein the first webpage element is a first advertisement and the second webpage element is a second advertisement.

16. The computer program product of claim 12 wherein the computer program product comprises at least one code segment configured to instruct a computer to:
determine whether a second webpage element or at least a portion thereof on the single webpage loaded by the browser is visible or partially visible on a display operatively connected to the computer, the second webpage element replacing the first webpage element;
track one or more second durations for when the second webpage element or at least a portion thereof is visible or partially visible on the display; and
so on until the single webpage is no longer loaded by the browser.

17. The computer program product of claim 12 wherein the computer program product comprises at least one code segment configured to instruct a computer to:
detect a resolution of the display;
detect the extent of maximization of a window containing the single webpage;
detect a position for the first webpage element on the single webpage;
detect a position for any vertical scrollbar of the window;
detect a position for any horizontal scrollbar of the window; and
detect whether the window is in a foreground position or other Z-order position in a GUI of the client computing device.

18. The computer program product of claim 12 wherein the computer program product comprises at least one code segment configured to instruct a computer to:
detect whether any portions of the window are obscured by any other windows appearing closer to the foreground by Z-order in the GUI.

19. A method of manipulating webpage elements on a single webpage based on visual queues, comprising:
loading a single webpage having at least one first webpage element and other webpage content;
determining whether the first webpage element or at least a portion thereof is visible or partially visible on a display;
manipulating the first webpage element when it is determined that the visibility of the first webpage element has changed.

20. The method of claim 19 wherein the first webpage element includes a rich internet application.
